(19) United States
(12) Patent Application Publication
(10) Pub. No.: US 2017/0108070 A1
(43) Pub. Date: Apr. 20, 2017

(54) HEAT DISSIPATION STRUCTURE FOR BRAKE PAD

(71) Applicant: Heng-Li Hsu, Changhua County (TW)

(72) Inventor: Heng-Li Hsu, Changhua County (TW)

(21) Appl. No.: 14/882,464

(22) Filed: Oct. 14, 2015

(51) Int. Cl. F16D 65/84; F16D 65/097; F16D 65/092

(52) U.S. Cl. CPC F16D 65/84; F16D 65/092; F16D 65/0971

(57) ABSTRACT

A heat dissipation structure for brake pad comprises a brake pad and a heat dissipation pad. The brake pad has an assembly portion arranged one side thereof The heat dissipation pad has an accommodating portion arranged at one side thereof The accommodating portion is slidably assembled to the assembly portion and contacted with each other tightly. When the brake pad is rubbed excessively and needs to be replaced, the heat dissipation pad which is arranged at the rake pad may be slidably disassembled from the assembly portion through the accommodating portion. The disassembled heat dissipation pad may be assembled to a new brake pad to keep reusing to conform to more economic benefits and has better practicability.

### BACKGROUND OF THE INVENTION

1. Field of the Invention

The present invention relates to a heat dissipation structure for brake pad, and especially relates to a heat dissipation structure which is detachable so that the heat dissipation may be disassembled and then assembled to another brake pad to keep reusing to more economic benefits and has better practicability.

2. Description of Related Art

The conventional brake pad mainly comprises a plate body. A brake plate body may be fastened at one surface of the plate body. The other surface which is opposite to the brake plate has a plurality of heat dissipation posts. When braking, the heat of the brake plate body which is generated from rubbing the rim may be dissipated to extend the service life of the brake pad. But the conventional brake pad has many disadvantages.

Firstly, when the brake pad is damaged and needs to be replaced, the brake pad must be replaced with the plate body and the heat dissipation pad. Actually, the plate body and the heat dissipation pad are not damaged. It will be wasted if the plate body and the heat dissipation pad which are not damaged are replaced.

Secondly, when replacing, the whole brake pad must be replaced and then the material cost is high so that the price of the products may not be reduced. For consumers, the price is too high to burden and easy to impair the buying desires. Furthermore, the industries are hard to upgrade.

Thirdly, the development and manufacturing cost of the molds which have the integrated structure of the brake pad and the heat dissipation pad are too high because the heat dissipation posts are extended from one side of the plate body outwardly and have a predetermined length with a cylindrical shape. The price is hard to reduced. For the consumers and the manufacturers, win-win situation may not be achieved.

In view of the foregoing circumstances, the inventor has invested a lot of time to study the relevant knowledge, compare the pros and cons, research and develop related products. After quite many experiments and tests, the “heat dissipation structure for brake pad” of this invention is eventually launched to improve the foregoing shortcomings, to meet the public use.

### SUMMARY OF THE INVENTION

An object of this invention is providing a heat dissipation structure for brake pad. The structure is detachable so that the heat dissipation may be disassembled and then assembled to another brake pad to keep reusing to more economic benefits and has better practicability.

Another object of this invention is providing a heat dissipation structure for brake pad. Each element may be assembled together after being manufactured respectively so that the cost of mold development and manufacturing may be reduced and the cost of production may also be reduced.

In order to achieve above mentioned effects, a heat dissipation structure for brake pad is provided. The heat dissipation structure may comprise a brake pad, having an assembly portion arranged one side thereof; and a heat dissipation pad, having an accommodating portion arranged at one side thereof, and the accommodating portion is slidably assembled to the assembly portion and contacted with each other tightly.

In some embodiments, a convex block is arranged at the assembly portion and a sliding groove is arranged at the accommodating portion, and the convex block is slidably assembled in the sliding groove.

In some embodiments, the convex block is extended from top to bottom, the sliding groove is extended from top to bottom, the sliding groove is slid from a wider end of the convex block to a narrower end of the convex block which is opposite to the wiser end of the convex block so that the convex block is slid in the sliding groove.

In some embodiments, the sliding groove is penetrated from top to bottom.

In some embodiments, the heat dissipation pad has a plurality of heat dissipation posts, and each of the heat dissipation posts is arranged at one side of the heat dissipation pad which is opposite to the accommodating portion.

In some embodiments, a brake shoe is arranged at the brake pad and located below one side of the brake pad which is opposite to the assembly portion.

In some embodiments, the assembly portion has a screw hole, the accommodating portion has a through hole, and a screw bolt is screwed through the through hole and the screw hole for connection.

In some embodiments, the heat dissipation structure further comprises an elastic member and an abutting member, and the assembly portion has an accommodating groove and the accommodating portion has a clamping hole, the elastic member and the abutting member are arranged in the accommodating groove, and two ends of the elastic member are respectively elastically abut against the accommodating groove and the abutting member, one end of the abutting member which is opposite to the elastic member has a convex post and the convex post is clamped in the clamping hole.

The various objectives and advantages of the present invention will be more readily understood from the following detailed description when read in conjunction with the appended drawing.

### BRIEF DESCRIPTION OF THE DRAWINGS

FIG. 1 is a perspective view of a heat dissipation structure for brake pad of the present invention;

FIG. 2 is an exploded view of the heat dissipation structure of the present invention;

FIG. 3 is a perspective view of the heat dissipation structure of the present invention in another angle;

FIG. 4 is a exploded view of FIG. 3;

FIG. 5 is a cross-sectional view of the heat dissipation structure of the present invention;

FIG. 6 is a view of the heat dissipation structure of the present invention which is arranged at a brake caliper;

FIG. 7 is an exploded view of another embodiment of the heat dissipation structure of the present invention; and

FIG. 8 is an exploded view of another types of the convex block and the sliding groove of the heat dissipation structure of the present invention.

### DETAILED DESCRIPTION OF THE INVENTION

To describe clearly that the present invention achieves the foregoing objective and function, the technical features and desired function are described with reference to a preferred embodiment and accompanying drawings.

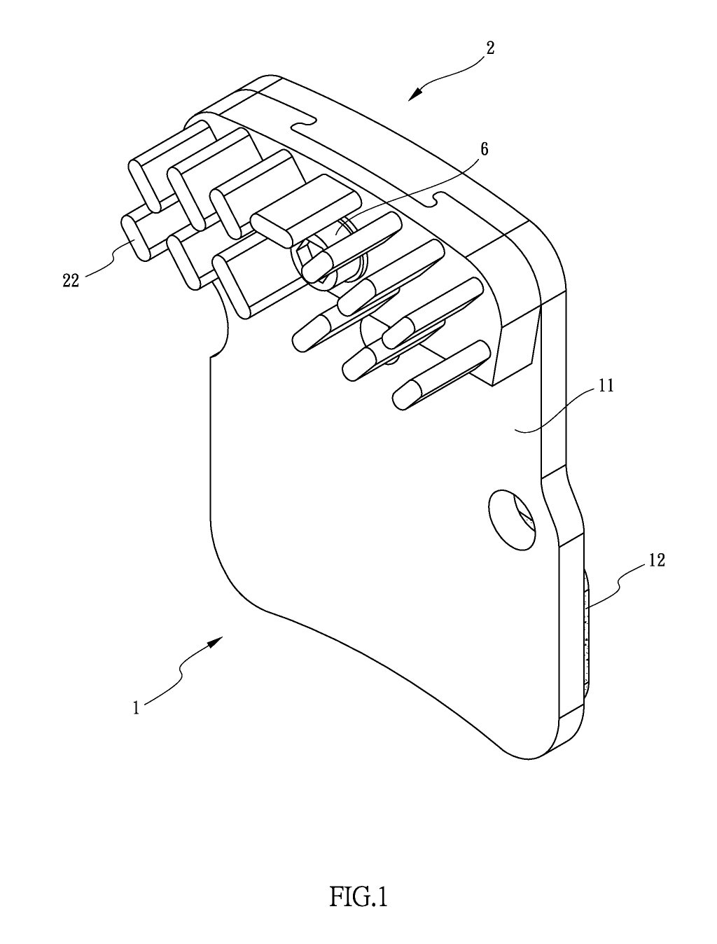

Please reference to FIGS. 1 to 6, a heat dissipation structure for brake pad of the present invention may comprise a brake pad 1 and a hear dissipation pad 2. The brake pad 1 may have an assembly portion 11 which is arranged one side of the brake pad 1. The heat dissipation pad 2 may have an accommodating portion 21 which is arranged at one side of the heat dissipation pad 2. The accommodating portion 21 is slidably assembled to the assembly portion 11 and contacted with each other tightly.

The brake pad 1 may be rectangular. One side of the brake pad 1 has the assembly portion 11 and one side of the heat dissipation pad 2 has an accommodating portion 21. The accommodating portion 21 is slidably assembled in the assembly portion 11 and contacted tightly with each other so that the heat dissipation 2 may be disassembled from the brake pad 1 or assembled to the brake pad 1 conveniently and the users who like DIY may have more desires to buy. (The above mentioned embodiment is the main skill feature of this invention and corresponds to the claim 1 of this invention to understand the objective and embodiments of this invention in detail. And the skill features of the depending claims are for describing the claim 1 in detail or adding more skill features, but not limited thereto. It should be known that the claim 1 is not necessary to include the skill features of the depending claims.)

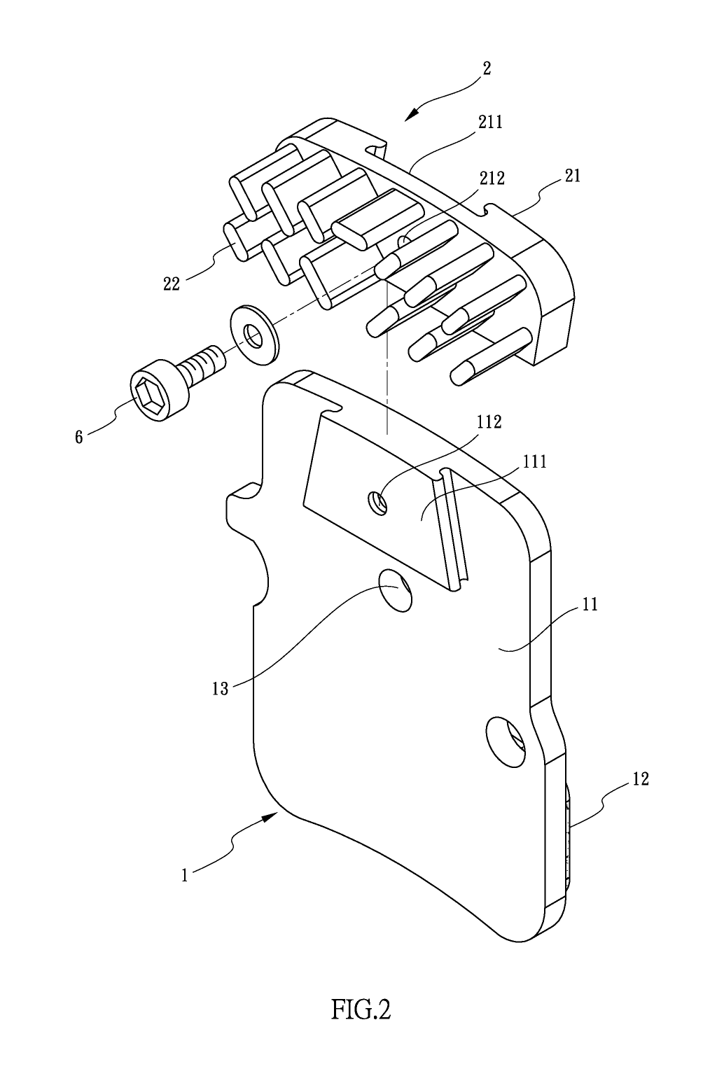

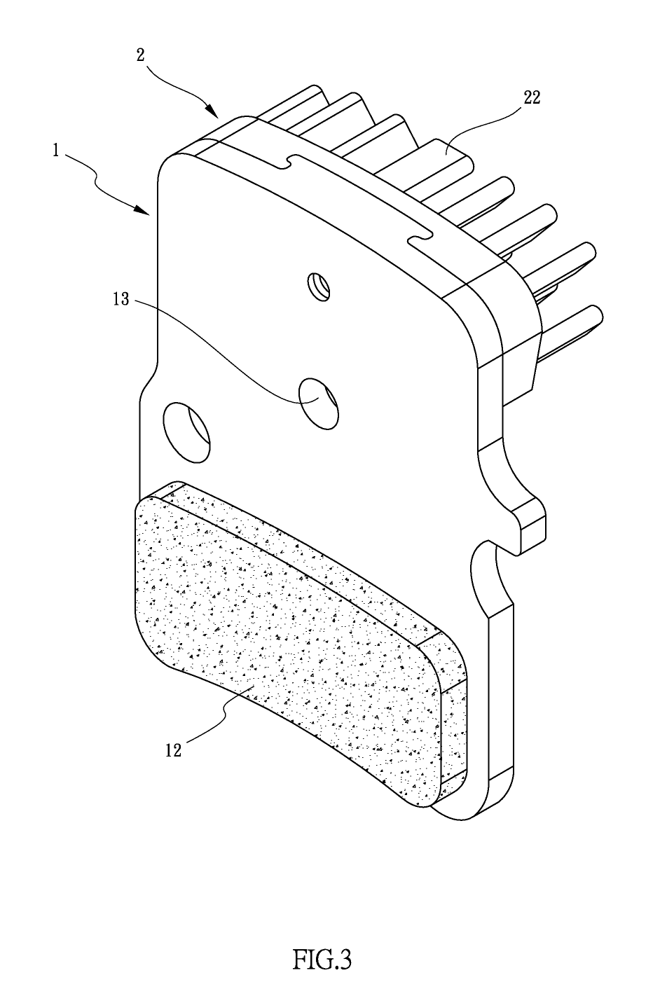

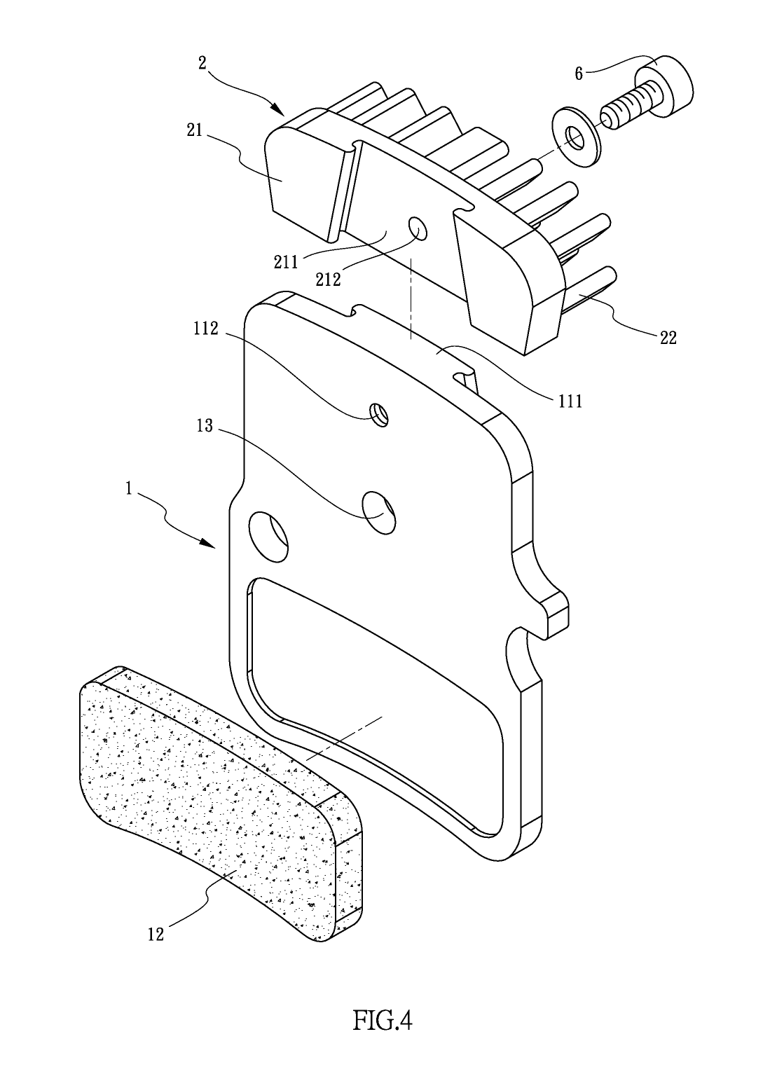

Please refer to FIGS. 2 and 4. The assembly portion 11 has a convex block 111 with a dovetail shape. The accommodating portion 21 has a sliding groove 211 with a dovetail shape which corresponds to the convex block 111 of the assembly portion 11 and assembled with each other. The convex block 111 is slidably arranged in the sliding groove 211 and contacted tightly with each other. A top surface of the accommodating portion 21 may be contacted with a top surface of the assembly portion 11 so that the top surface of the accommodating portion 21 may be not protruded from the top surface of the assembly portion 11 (shown as in FIGS. 1 and 3).

Please refer to FIGS. 2 and 4. The dovetail-shaped convex block 111 is extended from top to bottom and the dovetail-shaped sliding groove 211 is extended from top to bottom. The dovetail-shaped sliding groove 211 is slid from a wider end of the convex block 111 to a narrower end of the convex block 111 which is opposite to the wiser end of the convex block 111 so that the dovetail-shaped convex block 111 is slid in the dovetail-shaped sliding groove 211. The sliding groove 211 is penetrated from top to bottom. Besides the process in the processing factory may be more easily, the users may exactly know how to assemble while replacing.

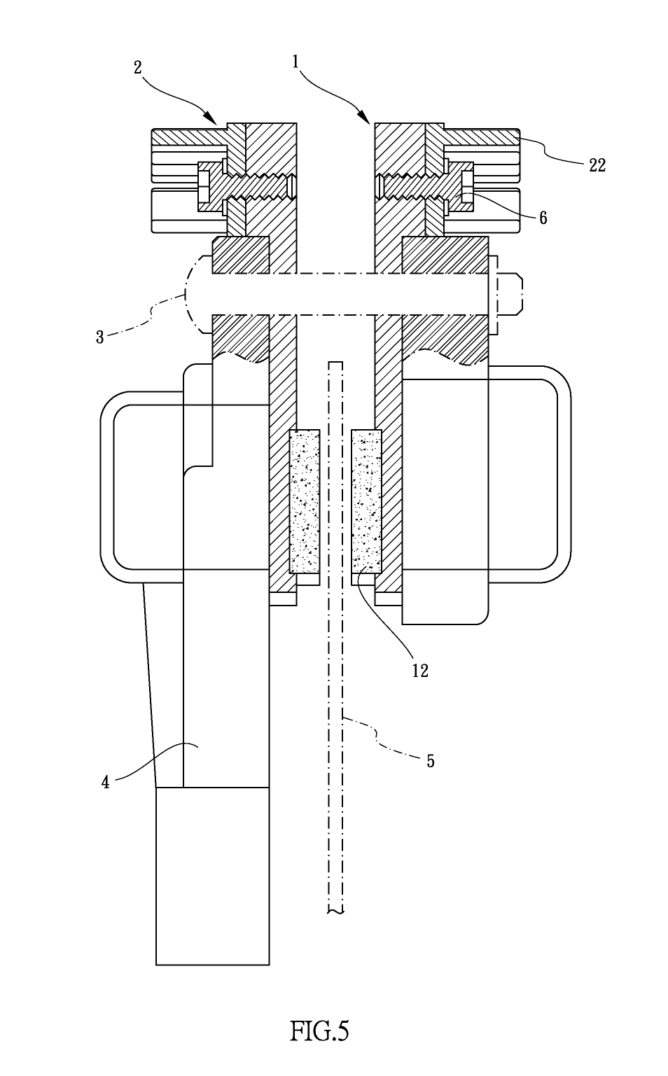

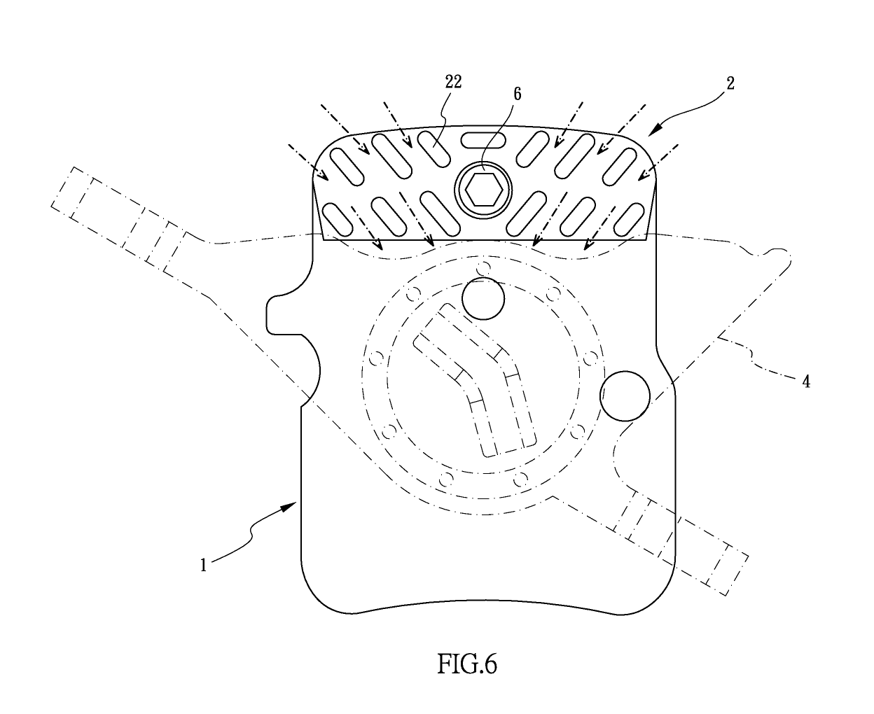

Please refer to FIGS. 1 and 2. A plurality of heat dissipation posts 22 are extended outwardly from the heat dissipation pad 2. Each of the heat dissipation posts 22 is a long elliptical cylinder. A left side and a right side of each heat dissipation posts 22 is symmetric for providing the guidance of the air to flow downwardly and toward a brake caliper 4 to reduce the temperature of the brake caliper 4 (shown as in FIG. 6). Each of the heat dissipation posts 22 is arranged opposite to the accommodating portion 21. Please also refer to FIGS. 2 to 4. A brake shoe 12 is further arranged at the brake pad 1 and located below one side of the brake pad 1 which is opposite to the assembly portion 11. A middle section of the brake pad 1 is arranged an intersecting hole 13. And further after a pivoting member 3 is passing through the intersecting hole 13, the brake pad 1 is assembled to the brake caliper 4 and located at two sides of a brake disc 5 (shown as in FIG. 5).

According to above mentioned structure, please refer to FIG. 5. While being assembled to two sides of the brake disc 5, the pivoting member 3 is passing through the intersecting hole 13 of the brake pad 1 to fasten on the brake caliper 4 so that the brake shoe 12 is toward the brake disc 5. While braking, the brake shoe 12 may be rubbed against the brake disc 5 to slow down. And simultaneously, the heat which is generated from the brake shoe 12 may be quickly dissipated by each heat dissipation post 22 of the heat dissipation pad 2 to keep good brake performance.

Please refer to FIG. 2. A center of the assembly portion 11 has a screw hole 112. A center of the heat dissipation pad 2 has a through hole 212. A screw bolt 6 is passing through the through hole 212 of the accommodating portion 21 and then screwed in the screw hole 112 of the assembly portion 11 so that he heat dissipation pad 2 may be locked and fastened to the brake pad 1 tightly (shown as in FIG. 1).

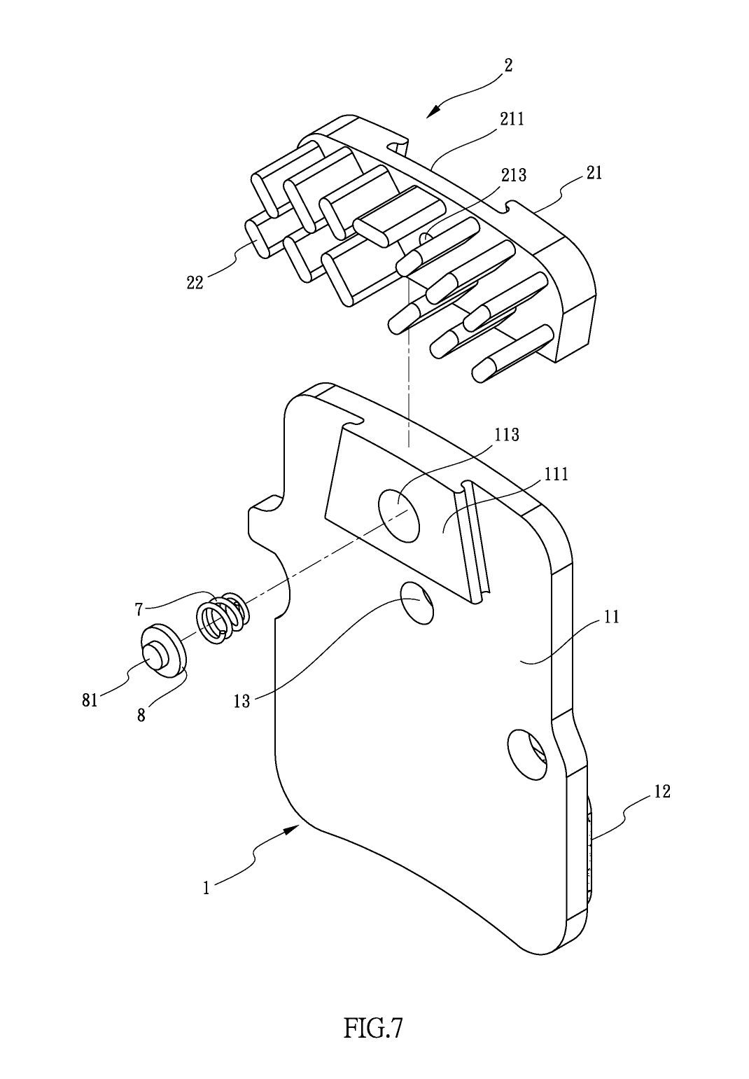

Please refer to FIG. 7. The heat dissipation structure of the present invention may further comprise an elastic member 7 and an abutting member 8. The assembly portion 11 has an accommodating groove 113 and the accommodating portion 21 has a clamping hole 213. The elastic member 7 and the abutting member 8 are arranged in the accommodating groove 113. Two ends of the elastic member 7 are respectively elastically abut against the accommodating groove 113 and the abutting member 8. One end of the abutting member 8 which is opposite to the elastic member 7 has a convex post 81 and the convex post 81 is clamped in the clamping hole 213. When the heat dissipation pad 2 is slid downwardly to assemble to the brake pad 1, the dovetail-shaped sliding groove 211 of the accommodating portion 21 is slid to assemble to the dovetail-shaped convex block 111 of the assembly portion 11. A bottom surface of the heat dissipation pad 2 may be abut against the convex post 81 of the abutting member 8 which is arranged in the accommodating groove 113 so that the abutting member 7 is abut against the elastic member 7 toward the accommodating groove 113. When the heat dissipation pad 2 is slid to be positioned, the abutting member 8 is elastically abut against the elastic member 7 to make the convex post 81 be clamped in the clamping hole 213 so that the heat dissipation pad 2 may be firmly assembled to the brake pad 1. When disassembling the heat dissipation pad 2, the convex post 81 is pressed to separate from the clamping hole 213 and then the heat dissipation pad 2 is slid upwardly to finish disassembling.

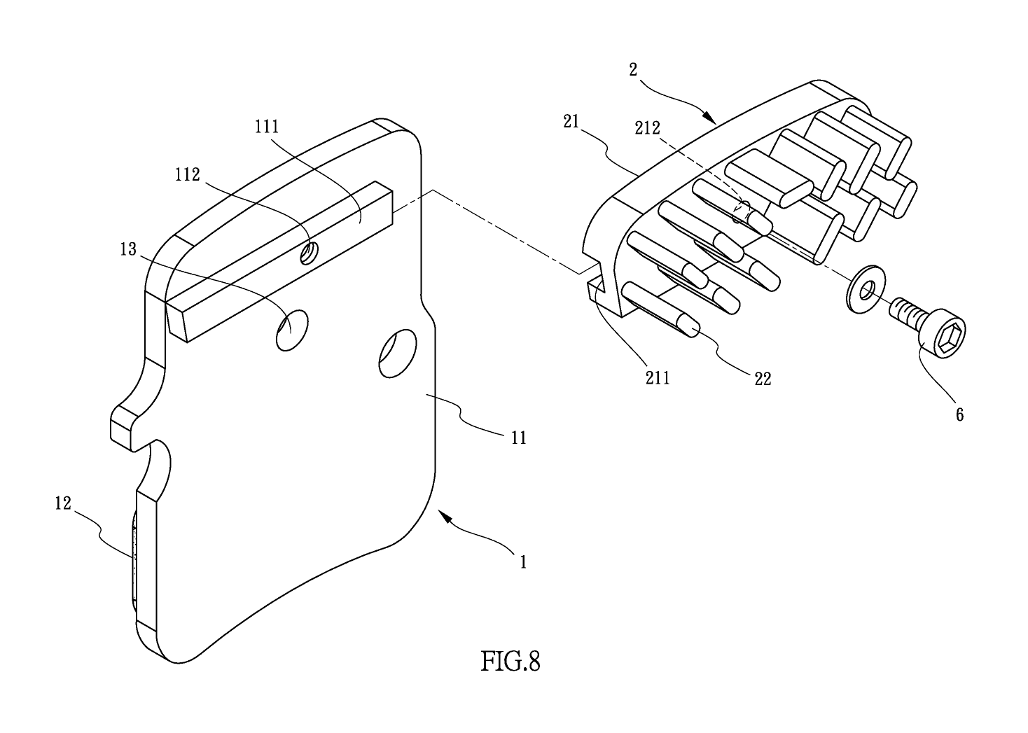

Please refer to FIG. 8. Besides the above mentioned assembly of the convex block 111 and the sliding groove 211, another assembly is that the sliding groove 211 is slid from a right side of the convex block 111 so that the convex block 111 may be slid into the sliding groove 211. Besides the process in the processing factory may be more easily, the users may exactly know how to assemble and what the direction is while replacing.

When the brake shoe 12 is rubbed to be damaged and needs to replace, the screw bolt 6 may be screwed out or the convex post 81 may be pressed to separate the heat dissipation pad 2 from the brake pad 1. The heat dissipation pad 2 which is not damaged may be reused. That is, the heat dissipation pad 2 may keep using. It means that the heat dissipation pad 2 which is not damaged may be replaced to assemble to an assembly portion 11 of another brake pad 1 to reuse for providing the effect of heat dissipation.

Compared to the conventional brake pad, the heat dissipation structure for brake pad of the present invention may conform to more economic benefits and has better practicability. Therefore, the present invention may has practicability and be industrially applicable. In order to make the Examiner know more about what the present invention may achieve the effects and values, the detail descriptions are as follows.

When replacing the damaged brake shoe 12, the heat dissipation pad 2 which is not damaged may be disassembled and then assembled to a new brake pad 1 to keep reusing. It can be not wasted and has the effects of environmental protection and economic benefits.

The damaged brake shoe 12 is replaced only but the heat dissipation pad 2 may not be replaced. The practicability may be better and the material cost may be reduced to ease the users' burden.

The brake pad 1 and the heat dissipation pad 2 are detachable. For the manufacturers, it may reduce the cost of develop molds and then the price of the products may be reduced. For the consumers, they may select this kind of products for first priority due to the reducing price. And it may also advantageous to upgrade the industries. Besides, the users who like DIY have more selections and funs.

The heat of the brake shoe 12 which is generated from rubbing the brake disc 5 may be directly transmitted from the brake caliper 4 to the heat dissipation pad 2 to dissipate. Therefore, the heat dissipation structure of the present invention may have the effect of reducing the temperature of the brake caliper 4 and extend the service life of the brake caliper 4.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

1. A heat. dissipation structure for brake pad, comprising:
a brake pad, having an assembly portion arranged one side thereof and the assembly portion having a screw hole; and
a heat dissipation pad, having an accommodating portion arranged at one side thereof, and the accommodating portion slidably assembled to the assembly portion and contacted with each other tightly, the accommodating portion having a through hole, a screw bolt extending through the through hole and threadedly connected to the screw hole.

2. The heat dissipation structure as claimed in claim 1, wherein a convex block is arranged at the assembly portion and a sliding groove is arranged at the accommodating portion, and the convex block is slidably assembled in the sliding groove.

3. The heat dissipation structure as claimed in claim 2, wherein the convex block is extended from top to bottom, the sliding groove is extended from top to bottom, the sliding groove is slid from a wider end of the convex block to a narrower end of the convex block which is opposite to the wiser end of the convex block so that the convex block is slid in the sliding groove.

4. The heat dissipation structure as claimed in claim wherein the sliding groove is penetrated from top to bottom.

5. The heat dissipation structure as claimed in claim 3, wherein the sliding groove is penetrated from top to bottom.

6. The heat dissipation structure as claimed in claim 1, wherein the heat dissipation pad has a plurality of heat dissipation posts, and each of the heat dissipation posts is arranged at one side of the heat dissipation pad which is opposite to the accommodating portion.

7. The heat dissipation structure as claimed in claim 1, wherein a brake shoe is arranged at the brake pad and located below one side of the brake pad which is opposite to the assembly portion.

8. (canceled)

9. The heat dissipation structure as claimed in claim 1, further comprising an elastic member and an abutting member, and the assembly portion has an accommodating groove and the accommodating portion has a clamping hole, the elastic member and the abutting member are arranged in the accommodating groove, and two ends of the elastic member are respectively elastically abut against the accommodating groove and the abutting member, one end of the abutting member which is opposite to the elastic member has a convex post and the convex post is clamped in the clamping hole.
